(19) United States
(12) Patent Application Publication
(10) Pub. No.: US 2017/0254941 A1
(43) Pub. Date: Sep. 7, 2017

(54) LIGHT GUIDE PLATE, BACKLIGHT MODULE AND DISPLAY DEVICE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventor: Zhiqiang FAN, Beijing (CN)

(73) Assignees: BOE TECHNOLOGY GROUP CO., LTD., Beijing (CN); BEIJING BOE OPTOELECTRONICS TECHNOLOGY CO., LTD., Beijing (CN)

(21) Appl. No.: 15/283,937

(22) Filed: Oct. 3, 2016

(30) Foreign Application Priority Data
Mar. 4, 2016 (CN) 201610125441.3

(51) Int. Cl. F21V 8/00

(52) U.S. Cl. CPC G02B 6/0021

(57) ABSTRACT

The present disclosure provides a light guide plate, a backlight module and a display device. The light-entering side of the light guide plate is provided with a groove for receiving at least a part of a light-emitting diode (LED) lamp. The backlight module includes the light guide plate. The display device includes the backlight module.

### CROSS-REFERENCE TO RELATED APPLICATIONS

This application claims priority to Chinese application No. 201610125441.3, filed Mar. 4, 2016, which is hereby incorporated by reference in its entirety.

### TECHNICAL FIELD

The present disclosure relates to the field of display technology, in particular to a light guide plate, a backlight module and a display device.

### BACKGROUND

In a side light-entering type backlight source structure commonly used in the related art, the light-entering side of a light guide plate is a plane. In addition, there is a certain distance between a light-emitting surface of a LED lamp and the light guide plate in an assembled state, so that only part of light emitted from the LED lamp can enter the light guide plate and be used, thereby not only resulting in a waste of energy of the energy source, but also affecting backlight luminance. Meanwhile, since assembly errors occur in the process of assembling the LED to a lamp bar and will cause the light-entering surface of the LED lamp not in alignment with the light-emitting surface of the light guide plate, light emitted by the LED lamp cannot be effectively injected into the light guide plate, resulting in decrease in backlight luminance and uniformity.

### SUMMARY

In view of this, the present disclosure provides a light guide plate, and a backlight module, that can improve light utilization of a LED lamp.

The light guide plate provided in the present disclosure based on the above-mentioned purpose is provided with a groove for receiving at least a part of the LED lamp at the light-entering side of the light guide plate.

Optionally, the groove comprises at least two side walls, one of the at least two side walls being a side wall in parallel with a light-emitting surface of the light guide plate, the another of the at least two side walls being a light-entering surface of the light guide plate.

Optionally, the groove further comprises two side walls perpendicular to the light-emitting surface of the light guide plate.

Optionally, the groove receives a part of the LED lamp.

Optionally, a length of the side wall of the groove in parallel with the light-emitting surface of the light guide plate extending along a direction perpendicular to the light-entering surface of the light guide plate accounts for 1%-50% of a total length of the LED lamp extending along the direction perpendicular to the light-entering surface of the light guide plate.

Optionally, a length of each of the two side walls of the groove perpendicular to the light-emitting surface of the light guide plate extending along a direction perpendicular to the light-emitting surface of the light guide plate is identical to a length of the light-entering surface of the light guide plate extending along the direction perpendicular to the light-emitting surface of the light guide plate.

Optionally, a depth of the groove along a direction perpendicular to the light-emitting surface of the light guide plate is identical to a thickness of the LED lamp along the direction perpendicular to the light-emitting surface of the light guide plate.

Meanwhile, the present disclosure also provides a backlight module including a light guide plate and a LED lamp, where the light guide plate includes a groove for receiving at least a part of the LED lamp arranged at a light-entering side of the light guide plate.

Optionally, the groove comprises at least two side walls, one of the at least two side walls is in parallel with a light-emitting surface of the light guide plate, and another of the at least two side walls is a light-entering surface of the light guide plate.

Optionally, the groove further comprises two side walls perpendicular to the light-emitting surface of the light guide plate.

Optionally, the two side walls perpendicular to the light-emitting surface of the light guide plate are perpendicular to the light-entering surface of the light guide plate.

Optionally, at least a part of the LED is received in a space enclosed by the side wall of the groove in parallel with the light-emitting surface of the light guide plate, the light-entering surface of the light guide plate, and the two side walls perpendicular to the light-emitting surface of the light guide plate.

Optionally, a length of the side wall of the groove in parallel with the light-emitting surface of the light guide plate extending along a direction perpendicular to the light-entering surface of the light guide plate accounts for 1%-50% of a total length of the LED lamp extending along the direction perpendicular to the light-entering surface of the light guide plate.

Optionally, a length of each of the two side walls of the groove perpendicular to the light-emitting surface of the light guide plate extending along a direction perpendicular to the light-emitting surface of the light guide plate is identical to a length of the light-entering surface of the light guide plate extending along the direction perpendicular to the light-emitting surface of the light guide plate.

Optionally, a depth of the groove along a direction perpendicular to the light-emitting surface of the light guide plate is identical to a thickness of the LED lamp along the direction perpendicular to the light-emitting surface of the light guide plate.

Optionally, the backlight module further includes a LED lamp; the LED lamp is provided in the groove.

Further, the present disclosure also provides a display device, including the backlight module provided in any one embodiment of the present disclosure.

As can be seen from the foregoing, with respect to the problem existing in the related art, the light guide plate, the backlight module and the display device provided in the present disclosure propose a simple and effective new backlight source structure, which is provided with a groove for receiving the LED lamp on the light-entering side of the light guide plate, shortens the distance between the light guide plate and the LED lamp, reduces the difficulty of assembling the LED lamp and improves the accuracy of alignment of the LED lamp on the light guide plate; meanwhile, the side walls of the groove can absorb light scattered by the LED lamp around and improve the luminance of the backlight module. Further, the groove of the disclosed embodiments has side walls in parallel with the light-emitting surface of the light guide plate and away from the light-emitting surface of the light guide plate, can reduce unevenness of luminance in the presence of errors in the assembling of the LED lamp, improve uniformity of luminance of the backlight source, and improve the lighting effect of the backlight module.

### DESCRIPTION OF THE DRAWINGS

FIG. 1 is a schematic view of a light guide plate in the related art;

FIG. 2 is a schematic view of a groove structure at a light-entering side of a light guide plate in some embodiments of the present disclosure;

FIG. 3 is a schematic view of a backlight module in some embodiments of the present disclosure; and

FIG. 4 is a schematic view showing a case when errors occur in the assembling of an LED lamp.

### DETAILED DESCRIPTION

As required, detailed embodiments are disclosed herein. However, it is to be understood that the disclosed embodiments are merely exemplary and that various and alternative forms may be employed. The figures are not necessarily to scale. Some features may be exaggerated or minimized to show details of particular components. Therefore, specific structural and functional details disclosed herein are not to be interpreted as limiting, but merely as a representative basis for teaching one skilled in the art.

In order to more clearly illustrate of the technical problem to be solved, the technical solution and advantages of the present disclosure, the detailed description will be given below in conjunction with the accompanying drawings and the specific embodiments.

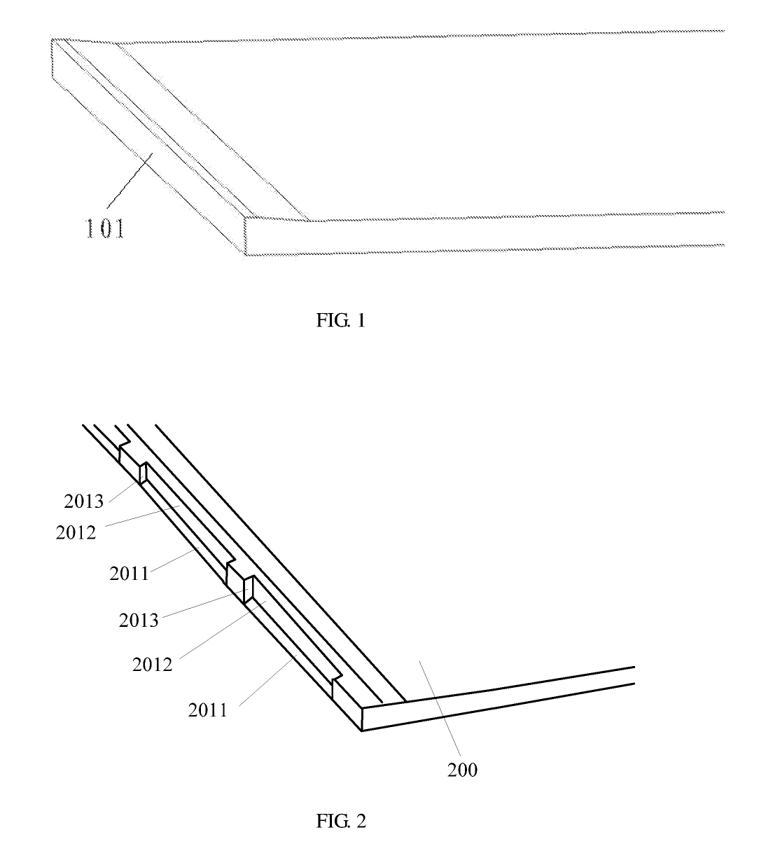

FIG. 1 is a side light-entering type backlight source structure commonly used in the related art. The light-entering side 101 of the light guide plate is a plane. In addition, there is a certain distance between a light-emitting surface of a LED lamp and the light guide plate in an assembled state, so that only part of light emitted from the LED lamp can enter into the light guide plate and be used, thereby not only resulting in a waste of energy of the energy source, but also affecting backlight luminance adversely. Meanwhile, since assembly errors occur in the process of assembling the LED to a lamp bar and will cause the light-entering surface of the LED lamp not in alignment with the light-emitting surface of the light guide plate, light emitted by the LED lamp cannot effectively enter into the light guide plate, resulting in decrease in backlight luminance and uniformity.

The present disclosure provides a light guide plate of which the structure is shown in FIG. 2, where the light-entering side of the light guide plate 200 is provided with a groove for receiving at least a part of the LED lamp.

It can be seen from the foregoing, the light guide plate provided in the present disclosure has a groove for receiving the LED lamp. The LED lamp is assembled in the groove, thereby to shorten the interval between the light guide plate and the LED lamp and meanwhile increase the contact area of the LED lamp and the light guide plate, so that light emitted by the LED lamp can enter into the light guide plate more effectively, whereby the luminance of the backlight module employing this kind of light guide plate can be improved. The LED lamp may be assembled directly into the groove, so a standard of the assembly precision is decreased, and the alignment accuracy the LED lamp is improved.

In some embodiments of the present disclosure, the groove includes at least two side walls.

For example, the groove has two side walls, where one is a light-entering surface of the light guide plate, and the other is in parallel with the light-emitting surface of the light guide plate and in alignment with the light-emitting surface of the light guide plate. Or the groove has two side walls, where one is the light-entering surface of the light guide plate, the other is in parallel with the light-emitting surface of the light guide plate and away from the light-emitting surface of the light guide plate.

For another example, the groove has three side walls, one is a light-entering surface of the light guide plate, and the other two side walls are in parallel with each other and perpendicular to the light-entering surface of the light guide plate and the light-emitting surface of the light guide plate. Or the groove has three side walls, one is a light-entering surface of the light guide plate, the other two are in parallel with each other and in parallel with the light-emitting surface of the light guide plate.

Again, in order to avoid unnecessary increase in the thickness of the light guide plate because of the groove, the groove has four side walls, one is the light-entering surface of the light guide plate, one is in parallel with and in alignment with the light-emitting surface of the light guide plate, and the other two are perpendicular to the light guide plate. Or, in order to avoid unnecessary increase in the thickness of the light guide plate because of the groove, the groove has four side walls, one is the light-entering surface of the light guide plate, one is in parallel with and away from the light-emitting surface of the light guide plate, the other two are perpendicular to the light-emitting surface of the light guide plate.

Optionally, the groove has five side walls, one is the light-entering surface of the light guide plate, another two are in parallel with each other and in parallel with the light-emitting surface of the light guide plate, yet another two are in parallel with each other and perpendicular to the light-entering surface of the light guide plate and the light-emitting surface of the light guide plate.

In some embodiments of the present disclosure, the groove is surrounded by at least two side walls, one side wall is in parallel with the light-emitting surface of the light guide plate, the other side wall is the light-entering surface of the light guide plate.

Specifically, the groove includes two side walls, one side wall is in parallel with the light-emitting surface of the light guide plate and away from the light-emitting surface of the light guide plate, and the other side wall is the light-entering surface of the light guide plate.

Specifically, when the groove includes two side walls perpendicular to the light-emitting surface of the light guide plate and a light-entering surface of the LED lamp, the spacing between the two side walls is equal to or greater than a width of the LED lamps, so that the LED lamps can be normally assembled without the decrease in the number.

In some embodiments of the present disclosure, still referring to FIG. 2, the groove 201 includes two side walls. One side wall is in parallel with the light-emitting surface of the light guide plate and in alignment with the light-emitting surface of the light guide plate, the other side wall is the light-entering surface 2012 of the light guide plate.

In some embodiments of the present disclosure, still referring to FIG. 2, the groove 201 further includes two side walls 2013 perpendicular to the light-emitting surface of the light guide plate.

In some embodiments of the present disclosure, it is characterized in that the groove receives a part of the LED lamp. That is, the LED lamp is partly located in the groove so that the LED lamp can effectively scatter heat.

In some embodiments of the present disclosure, the groove may also receive the entire LED lamp so as to facilitate the assembling of the LED lamp.

In some embodiments of the present disclosure, a length of the side wall of the groove in parallel with the light-emitting surface of the light guide plate extending along a direction perpendicular to the light-entering surface of the light guide plate accounts for 1%-50% of a total length of the LED lamp extending along the direction perpendicular to the light-entering surface of the light guide plate.

In some embodiments of the present disclosure, the ratio of the groove along the light-emitting surface of the light guide plate to the total length of the LED lamp may be made as small as possible.

In some embodiments of the present disclosure, the greater the ratio of the part of the LED lamp embedded in the groove to the entire LED lamp, the better the luminance enhancement effect of the backlight module; and the smaller the ratio of the part of the LED lamp embedded in the groove to the entire LED lamp, the better the heat dissipation effect of the LED lamp. In a specific embodiment, in different types of backlight modules, the ratio of the part of the LED lamp embedded in the groove may vary and this ratio may be measured experimentally in the production.

In some embodiments of the present disclosure, a length of each of the two side walls of the groove perpendicular to the light-emitting surface of the light guide plate extending along a direction perpendicular to the light-emitting surface of the light guide plate is identical to a length of the light-entering surface of the light guide plate extending along the direction perpendicular to the light-emitting surface of the light guide plate.

In some embodiments of the present disclosure, a depth of the groove along the direction perpendicular to the light-emitting surface of the light guide plate is identical to a thickness of the LED lamp along the direction perpendicular to the light-emitting surface of the light guide plate.

In some embodiments of the present disclosure, the groove has four side walls, one is the light-entering surface of the light guide plate, one is in parallel with and away from the light-emitting surface of the light guide plate, and another two are perpendicular to the light-emitting surface of the light guide plate. When the height of the LED lamp is less than the thickness of the light guide plate, the depth of the groove perpendicular to the direction of the light-emitting surface of the light guide plate. The side walls of the groove in parallel with the light-emitting surface of the light guide plate and away from the light-emitting surface of the light guide plate is in alignment with the surface opposite to the light-emitting surface of the light guide plate; or the tops of the two surfaces of the groove perpendicular to the light-emitting surface of the light guide plate are in alignment with the light-emitting surface of the light guide plate, so as to increase the efficient contact area of the light guide plate and an adhesive tape, improve the stability of the backlight module structure and can reduce the structure damages generated due to shakes in the product transportation process.

Meanwhile, the present disclosure further provides a backlight module including the light guide plate in some embodiments of the present disclosure.

In the related art, the light-entering side of the light guide plate is a plane, and due to the presence of errors in the process of assembling the LED to a light bar, the light-emitting surfaces of the LED lamps are not on the same plane. As shown in FIG. 4, the light-emitting surfaces of all the LED lamps 401 are not on the same plane, and in a correct assembly state, the light-emitting surfaces of all the LED lamps 401 should be located on the plane denoted by the dotted line which is in parallel with the light-entering surface of the light guide plate 402. However, in actual operations, the light-emitting surfaces of the LED lamps may deviate, and the light-emitting surfaces of a plurality of LED lamps might not be able to be located on the same plane, and a part of the LED lamps titled. Since assembly errors of the LED lamps cause the angle of the outgoing light to change, a part of light will be incident on a backplane or on a plastic frame and cannot be completely incident on the light guide plate, resulting in decrease in light utilization and decrease in luminance of the backlight source, and at the same time, the tilting of part of the LED lamps may further affect the overall uniformity of the backlight.

With respect to the backlight module provided in some embodiments of the present disclosure, the light-entering side of the light guide plate is provided with a groove corresponding to the LED lamp, and a part of the LED lamp is embedded in the light guide plate, thereby to increase the contact area of the light guide plate with the LED lamp, so that light emitted by the LED lamp is directly incident to the light guide plate as much as possible so as to be utilized in order to achieve the purpose of increasing the backlight luminance, while the structure can further address the problem that errors occurring in the process of assembling the LED lamp to a lamp bar cause the light-emitting surface of the LED lamp not in alignment with the light-entering surface of the light guide plate and result in low luminance and uniformity; even in a case where the light-emitting surfaces are not on the desired assembling plane when a plurality of LED lamps on the lamp bar are assembled, luminance of the part with assembly errors will not be affected greatly. Moreover, in some embodiments of the present disclosure, the groove has two side walls mutually in parallel with each other and perpendicular to the light-entering side of the light guide plate and to the light-emitting side of the lamp bar, the tops of the two side walls are in alignment with the light-emitting surface of the light guide plate. This design increases the effective bonding area of the lamp bar, the adhesive tape and the light guide plate to improve the structural stability, thereby improving the quality reliability of the backlight source to a certain extent.

In some embodiments of the present disclosure, the backlight module further includes an LED lamp provided in the groove.

In some embodiments of the present disclosure, a length of the side wall of the groove in parallel with the light-emitting surface of the light guide plate extending along a direction perpendicular to the light-entering surface of the light guide plate accounts for 1%-50% of a total length of the LED lamp extending along the direction perpendicular to the light-entering surface of the light guide plate. Accordingly, the length of part of the LED lamp embedded into the groove accounts for 1%-50% of the total length of the LED lamp, i.e., the LED lamp is partially embedded in the groove.

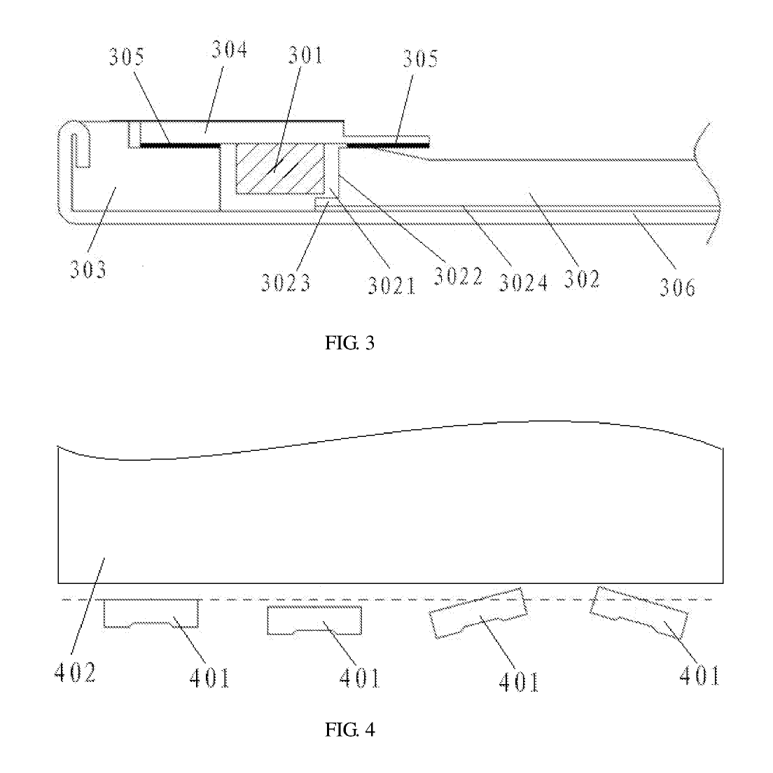

The backlight module provided in some embodiments of the present disclosure as shown in FIG. 3 includes an LED 301, a light guide plate 302, an adhesive frame 303, a flexible circuit board 304, an adhesive tape 305, a backplane 306. The LED 301 and the light guide plate 302 are provided in the backplane 306, the adhesive frame 303 is located on the side of the LED lamp 301 away from the light guide plate; the flexible circuit board 304 is provided above the light guide plate 302 and the LED lamp 301, the adhesive tape 305 is used for bonding the flexible circuit board 304. The LED lamp 301 is provided in the groove 3021 of the light guide plate 302 and partially embedded into the groove 3021.

In some embodiments of the present disclosure, still referring to FIG. 3, the groove 3021 has four side walls, one side wall is the light-entering surface 3022 of the light guide plate, two side walls are in parallel with each other and perpendicular to the light-emitting surface of the light guide plate and to the light-entering surface of the LED lamp, another side wall 3023 is in parallel with the light-emitting surface of the light guide plate 302 and in alignment with the surface 3024 opposite to the light-emitting surface of the light guide plate. When assembled, the LED lamp 301 is placed between two side walls in parallel with each other and perpendicular to the light-emitting surface of the light guide plate and to the light-entering surface of the LED lamp, the light-emitting surface of the LED lamp 301 is opposite to the light-entering surface of the light guide plate 302, part of light emitted from the LED lamp 301 and scattering around can be reflected by the side walls of the groove 3021, so that light utilization of the LED and the like is improved.

In the above embodiment, a part of the LED lamp 301 will be embedded in the groove 3021 of the light guide plate 302 after completion of assembling of the backlight module, so that the light guide plate 302 surrounds the three surfaces on the light-emitting side of the LED lamp 301, thereby increasing the contact area of the light guide plate 302 with the light source, increasing the utilization of light, and improving the luminance of the backlight source.

In a case of the presence of errors of assembling the LED lamp in some embodiments of the present disclosure, some light that may originally be incident on the backplane or the adhesive frame can also be directly incident into the light guide plate, and be well used, thereby increasing the luminance of the backlight source while increasing the contact area of the groove with the LED lamp, so that the amount of light incident on the light guide plate emitted from the light-emitting surface of the LED lamp is substantially equal. Since the amounts of light incident on the light guide plate from respective LED lamps are equivalent, the uniformity of the backlight source also will be improved.

Meanwhile, in some embodiments of the present disclosure, the LED lamp does not necessarily be embedded too much so as to ensure that the LED lamp leaves enough space to dissipate heat.

In some embodiments of the present disclosure, the groove has four side walls, one side wall is the light-entering surface of the light guide plate, two side walls are in parallel with each other and perpendicular to the light-emitting surface of the light guide plate and to the light-entering surface of the LED lamp, another side wall is in parallel with the light-emitting surface of the light guide plate and in alignment with the surface opposite to the light-emitting surface of the light guide plate. One end of the groove is in alignment with the light-emitting surface of the light guide plate. When assembled, the effective contact area of the light guide plate with an adhesive strip, a flexible circuit board and the like are increased, thereby improving the fastness of the bonding of the light guide plate with the adhesive strip as well as the structure liability of the backlight module.

Further, the present disclosure also provides a display device, comprising the backlight module provided in some embodiments of the present disclosure.

As can be seen from the foregoing, with respect to the problem existing in the related art, the light guide plate, the backlight module and the display device provided in the present disclosure propose a simple and effective new backlight source structure. A groove for receiving the LED lamp is arranged on the light-entering side of the light guide plate, thereby shortening the distance between the light guide plate and the LED lamp, reducing the difficulty of assembling the LED lamp and improving the accuracy of alignment of the LED lamp on the light guide plate. Meanwhile, the side walls of the groove can reflect light scattered around by the LED lamp and improve the luminance of the backlight module. Further, the groove in some embodiments of the present disclosure has side walls in parallel with the light-emitting surface of the light guide plate and away from the light-emitting surface of the light guide plate, thereby solving unevenness of luminance in the presence of errors in the assembling of the LED lamp, improving uniformity of luminance of the backlight source, and improving the lighting effect of the backlight module.

It should be understood that a plurality of embodiments described in this specification are illustrative only and explain the present disclosure, not to limit the present disclosure. Without conflict, the embodiments in the present application and features in the embodiments may be combined with each other.

Obviously, those skilled in the art can make various changes and modifications of the present disclosure without departing from the spirit and scope of the present disclosure. Thus, if such changes and modifications of the present disclosure fall within the scope of the claims of the present disclosure claims and their equivalents, the present disclosure is also intended to cover such changes and modifications.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A light guide plate, comprising a groove for receiving at least a part of a light-emitting diode (LED) lamp arranged at a light-entering side of the light guide plate.

2. The light guide plate according to claim 1, wherein the groove comprises at least two side walls, one of the at least two side walls is in parallel with a light-emitting surface of the light guide plate, and another of the at least two side walls is a light-entering surface of the light guide plate.

3. The light guide plate according to claim 2, wherein the groove further comprises two side walls perpendicular to the light-emitting surface of the light guide plate.

4. The light guide plate according to claim 3, wherein the two side walls perpendicular to the light-emitting surface of the light guide plate are perpendicular to the light-entering surface of the light guide plate.

5. The light guide plate according to claim 1, wherein the groove receives a part of the LED lamp.

6. The light guide plate according to claim 5, wherein a length of the side wall of the groove in parallel with the light-emitting surface of the light guide plate extending along a direction perpendicular to the light-entering surface of the light guide plate accounts for 1%-50% of a total length of the LED lamp extending along the direction perpendicular to the light-entering surface of the light guide plate.

7. The light guide plate according to claim 3, wherein a length of each of the two side walls of the groove perpendicular to the light-emitting surface of the light guide plate extending along a direction perpendicular to the light-emitting surface of the light guide plate is identical to a length of the light-entering surface of the light guide plate extending along the direction perpendicular to the light-emitting surface of the light guide plate.

8. The light guide plate according to claim 5, wherein a depth of the groove along a direction perpendicular to the light-emitting surface of the light guide plate is identical to a thickness of the LED lamp along the direction perpendicular to the light-emitting surface of the light guide plate.

9. A backlight module, comprising a light guide plate and a light-emitting diode (LED) lamp, wherein the light guide plate comprises a groove for receiving at least a part of the LED lamp arranged at a light-entering side of the light guide plate.

10. The backlight module according to claim 9, wherein the groove comprises at least two side walls, one of the at least two side walls is in parallel with a light-emitting surface of the light guide plate, and another of the at least two side walls is a light-entering surface of the light guide plate.

11. The backlight module according to claim 10, wherein the groove further comprises two side walls perpendicular to the light-emitting surface of the light guide plate.

12. The backlight module according to claim 11, wherein the two side walls perpendicular to the light-emitting surface of the light guide plate are perpendicular to the light-entering surface of the light guide plate.

13. The backlight module according to claim 12, wherein at least a part of the LED is received in a space enclosed by the side wall of the groove in parallel with the light-emitting surface of the light guide plate, the light-entering surface of the light guide plate, and the two side walls perpendicular to the light-emitting surface of the light guide plate.

14. The backlight module according to claim 13, wherein a length of the side wall of the groove in parallel with the light-emitting surface of the light guide plate extending along a direction perpendicular to the light-entering surface of the light guide plate accounts for 1%-50% of a total length of the LED lamp extending along the direction perpendicular to the light-entering surface of the light guide plate.

15. The backlight module according to claim 13, wherein a length of each of the two side walls of the groove perpendicular to the light-emitting surface of the light guide plate extending along a direction perpendicular to the light-emitting surface of the light guide plate is identical to a length of the light-entering surface of the light guide plate extending along the direction perpendicular to the light-emitting surface of the light guide plate.

16. The backlight module according to claim 13, wherein a depth of the groove along a direction perpendicular to the light-emitting surface of the light guide plate is identical to a thickness of the LED lamp along the direction perpendicular to the light-emitting surface of the light guide plate.

17. A display device, comprising the backlight module according to claim 9.
